(19) United States
(12) Patent Application Publication
(10) Pub. No.: US 2015/0229729 A1
(43) Pub. Date: Aug. 13, 2015

(54) METHOD AND SYSTEM FOR CROSS DEVICE TRACKING IN ONLINE MARKETING MEASUREMENTS

(71) Applicant: Business Development Company B.V., Hilversum (NL)

(72) Inventor: Maxim Alexander van der HEIJDEN, Utrecht (NL)

(21) Appl. No.: 14/592,941

(22) Filed: Jan. 9, 2015

(30) Foreign Application Priority Data
Feb. 7, 2014 (NL) 2012223

(51) Int. Cl. H04L 29/08; G06Q 30/02

(52) U.S. Cl. CPC H04L 67/22; G06Q 30/0246

(57) ABSTRACT

A device is used by a decision making unit to visit the web shop website directly or via a referring website, e.g. organic search, advertising channels, e-mail. The method starts by gathering data from a web shop website and associated product websites, the data including a product identification identifying a product for sale in the web shop website, and an IP address of the at least one device. A match of product identification and IP address of the at least one device is detected, and a customer journey from the decision making unit towards actual purchase of a product is assembled from all detected matches of product identification and IP address. The customer journey combines visit data associated with visits by the decision making unit to the web shop website and associated product websites using any of the at least one devices and relating to the purchased product.

### FIELD OF THE INVENTION

The present invention relates to a method for online marketing measurements relating to purchase of a product (or products) on a web shop website by a decision making unit, wherein at least one device is used by the decision making unit to visit the web shop website and associated product websites, e.g. advertisement sites, the method comprising gathering data from the web shop website and associated product websites.

### PRIOR ART

Traditional web analytics systems assign the order to the last visits to determine the performance of an advertising channel (last-cookie method). However, most online sales are the results of many visits, from many advertising websites. Therefore, traditional analytics systems are not reflecting the real contribution attributable to the various advertising channels.

International patent publication WO2013/074750 discloses a method for identifying and tracking user activity when using networked devices. The method is implemented to build a device graph using e.g. associations between identifiers, and to then use the device graph for various purposes, such as targeting of advertisements.

International patent publication WO2013/170198 discloses a method for correlation of various digital identities, such as computers and users thereof, on the Internet, in order to be able to provide direct advertisements. For this IP and MAC addresses, cookies, user id's, etc. are being used.

American patent publication US2012/054213 discloses a method to determine consumer behavior on e.g. the Internet, using visitation records. The visitation records comprise e.g. IP or MAC addresses, cookies, log in data, email addresses, account id's. Even when a consumer used different devices or even different networks, this determination can still be made.

### SUMMARY OF THE INVENTION

The present invention seeks to provide an improved tracking method allowing gathering of data associated with the customer journey of an internet based product purchase.

According to the present invention, a method according to the preamble defined above is provided, wherein the data comprises a product identification identifying a product for sale in the web shop website, and an IP address of the at least one device, and further comprising detecting a match of product identification and IP address of the at least one device, assembling a customer journey from the decision making unit towards actual purchase of a product from all detected matches of product identification and IP address, the customer journey combining visit data associated with visits by the decision making unit to the web shop website and associated product websites using any of the at least one devices and relating to the purchased product. It is noted that a device is used by the decision making unit to visit the web shop web site, directly or via a referring website, e.g. organic search, advertising channels, e-mail, etc. This allows to obtain a more complete customer journey than possible with prior art methods, even in the case of multiple devices being used by the decision making unit towards the purchase of the product.

In a further embodiment, the visit data comprises stored data saved on the at least one device during a visit to the web shop website or an associated product website by the decision making unit, the stored data comprising at least the product identification. The stored data is e.g. saved in a cookie or cookie file on the specific device used by the decision making unit.

A decision making unit identification is provided in a further embodiment to each of the at least one devices, such as an email address or an account identification, and the decision making unit identification is included in the gathered data. This provides further possibilities to make the customer journey more complete.

The visit data are obtained based on data retrieved from the decision making unit identification in a further embodiment. The decision making unit identification is e.g. based on an email address or account identification, available on the at least one device, or stored during an actual purchase at a physical store location where the email address (or other decision making unit identification) is obtained.

The visit data may comprise data obtained from at least one device during a visit of the web shop web site relating to user agent data and/or IP hash data. This is one of possible implementations, which dependent on the type of visit may be used as visit data in assembling the customer journey.

In a number of cases or situations, the gathering of the data to assemble a customer journey may not result in a useable customer journey. E.g. data from an IP address having more than a predetermined number of different decision making units are excluded in a further embodiment, a situation which may arise in the case of proxy servers being used, or in the case of large companies using a router. A further alternative embodiment is wherein data relating to matched product identification and IP address of the at least one device are excluded if a number of matches exceeds a predetermined threshold value, which may be the case for very popular products, hypes, launches, etc.

The customer journey and the gathered data is used in a further embodiment to compute contributions of separate points on the customer journey towards the actual sale of the product. As the customer journey is more complete than in prior art methods, the contributions can be computed more precisely.

In further aspects, the present invention also relates to a system for online marketing measurements relating to purchase of a product on a web shop website by a decision making unit, the system comprising a processing unit connected to the Internet, and arranged to execute the method according to any one of the present invention embodiments, as well as to a computer program product comprising computer executable code, which when loaded on a computing system, allows the computing system to execute the method according to any one of the present invention embodiments.

### SHORT DESCRIPTION OF DRAWINGS

The present invention will be discussed in more detail below, using a number of exemplary embodiments, with reference to the attached drawings, in which

FIG. 1 shows a timing diagram illustrating a customer journey assembled according to a prior art method;

FIG. 2 shows a timing diagram illustrating a customer journey assembled according to a first embodiment of the present invention;

FIG. 3 shows a timing diagram illustrating a customer journey assembled according to a second embodiment of the present invention;

FIG. 4 shows a timing diagram illustrating a customer journey assembled according to a third embodiment of the present invention;

### DETAILED DESCRIPTION OF EXEMPLARY EMBODIMENTS

Present day consumer products are more and more often sold via Internet channels. Distributors and sellers invest in advertisements in various new forms, such as Internet advertisements using various (social) media. Of course, it is worthwhile to be able to establish that a certain type of advertisement or web presence has resulted in an actual sale of a product.

Traditional web analytics systems assign the purchase to the last visits to determine the performance of an advertising channel (last-cookie method). However, most online sales are the results of many visits, from many advertising websites. Therefore, traditional analytics systems are not reflecting the real contribution attributable to the various advertising channels.

Applicant of this patent application has already described a novel method and system for online marketing measurements, see priority application NL2011176, which is incorporated herein by reference, as well as the related U.S. application Ser. No. 14/327,705, which is also incorporated herein by reference.

The present application relates to various embodiments which allow a better gathering of relevant data of a customer journey (or purchase track) of a customer (decision making unit) for a specific purchase of a product. The decision making unit as used in the description, is the entity making the eventual purchase. Normally a decision making unit thus comprises a single natural person (using a personal computer or other internet enabled device), but also multiple persons (e.g. a family) or even a computerized buying entity can be the entity covered by this term. This applies even when a customer (decision making unit) uses multiple devices during the entire customer journey (orientation, comparing prices, up until eventual purchase) or buys from a physical store after orientating online.

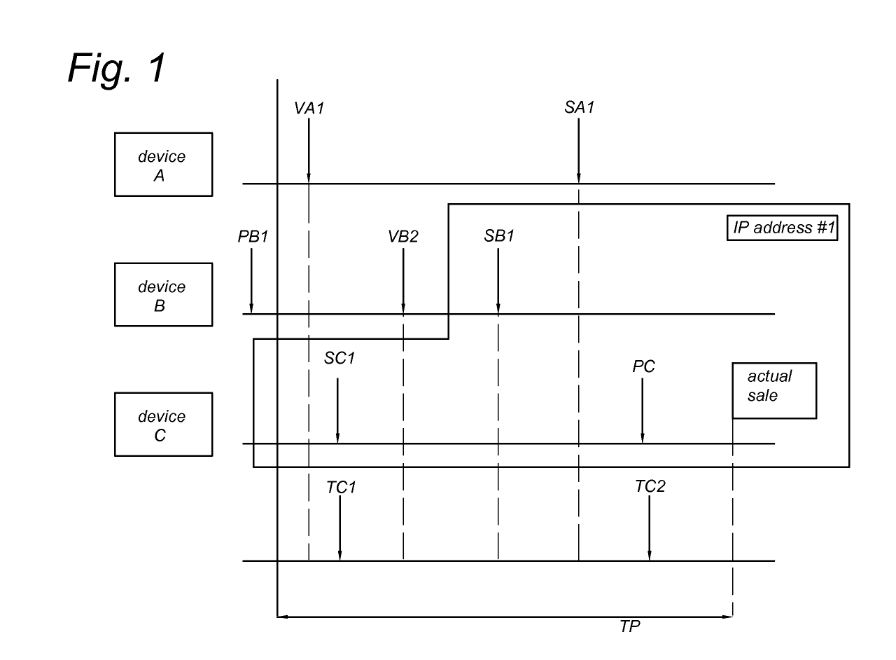

FIG. 1-4 show a timing diagrams illustrating a customer journey assembled according to a prior art method and embodiments of the present invention. In the timing diagrams, three different devices are used by the decision making unit, e.g. a device A (laptop), device B (tablet) and device C (desktop computer). Device B and device C are connected to the Internet using a single access point, indicated by the block with IP address #1. Note that prior to that, the device B was e.g. connected via another network, and hence another IP address, as indicated in the drawings. The device used by the decision making unit to make the eventual purchase is device C (indicated by block ‘actual sale’ at the right of the timing line for device C).

The journey resulting in the actual sale is of course the journey of interest from marketing perspective. Usually, the journey is limited over a certain predetermined tracking period TP, e.g. 30 days or counting from a previous purchase.

In this exemplary case, the decision making unit used all three devices to have a look at a specific product (e.g. a pair of shoes): first on device C (indicated as event S_{C1}), later in time on device B (indicated as event S_{B1}) and even later on device A (indicated as event S_{A1}). The actual purchase was initiated from device C (indicated as purchase event P_{C}). In each and every case, the product identification is available as visit data, and the visit is done at a web shop web site.

Furthermore, further visits were made to the same web shop web site or using other Internet related sites, such as advertising channels. These further visits may relate to the same or similar products, but may also concern other types of visits (e.g. visits to the home page, visits to a (non)related category page) using one of the devices A or B in this particular example. This is indicated by visit events V_{A1} using device A, and V_{B2} using device B. Also, an earlier purchase was made using device B, indicated as purchase event P_{B1}.

It is noted that the present invention embodiments relate to Internet related purchases in a very general sense. This implies that devices used by the decision making unit, and computer systems implementing a web shop web site and associated product web sites, such as advertisement web sites or channels, provide and store data related to each and every visit. The most common used implementation are cookies, which are stored as small files on a device and/or computer system, but other methods and implementations may be used.

In prior art methods, as indicated above, the customer journey is assembled using gathered visit data from device C only, in this case (using a tracking period TP of e.g. 30 days), the visit data is recorded for two instances or touch points, T_{C1} and T_{C2}. The visit data gathered on basis of this customer journey is of course somewhat limited, and cannot account for any possible contribution to the actual sale via the other devices used by the decision making unit.

According to a first embodiment of the present invention, a method is provided for online marketing measurements relating to purchase of a product on a web shop website by a decision making unit. At least one device (device A, B, C) is used by the decision making unit to visit the web shop website and associated product websites, such as advertisement sites or channels. The method comprises
gathering data from the web shop website and associated product websites, wherein the data comprises a product identification identifying a product for sale in the web shop website, and an IP address of the at least one device;
detecting a match of product identification and IP address of the at least one device;
assembling a customer journey from the decision making unit towards actual purchase of a product from all detected matches of product identification and IP address, the customer journey combining visit data associated with visits by the decision making unit to the web shop website and associated product websites using any of the at least one devices and relating to the purchased product.

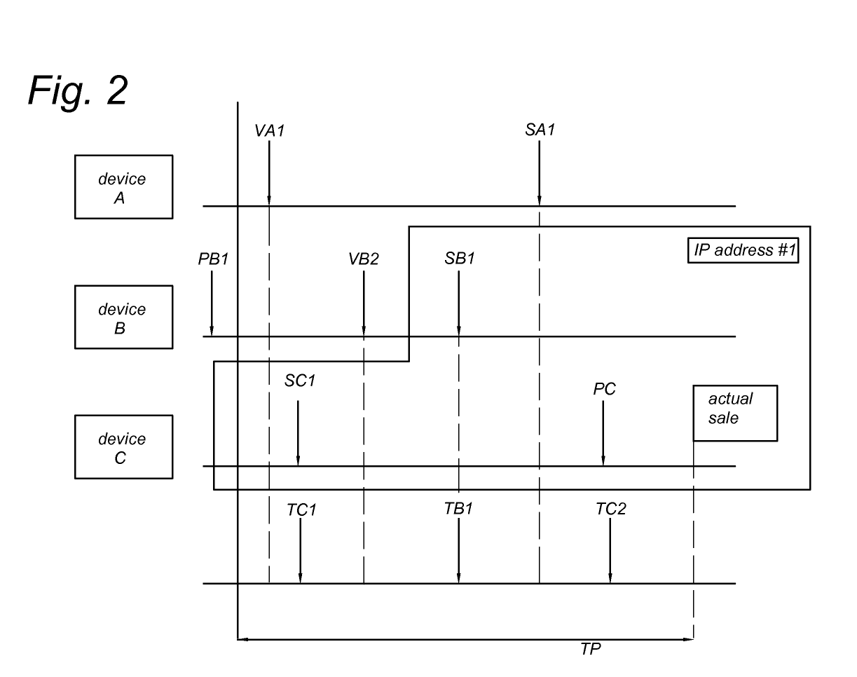

In this manner, the customer journey will also include data related to the visit to the web shop web site by the decision making unit using device B (event S_{B1}, included in the customer journey as touch point T_{B1}), as shown in FIG. 2. This customer journey is already more complete and thus more useful than prior art methods. It is noted that the combination of product identification and IP address as used in the present invention embodiments could also be secured, e.g. using a hashing method.

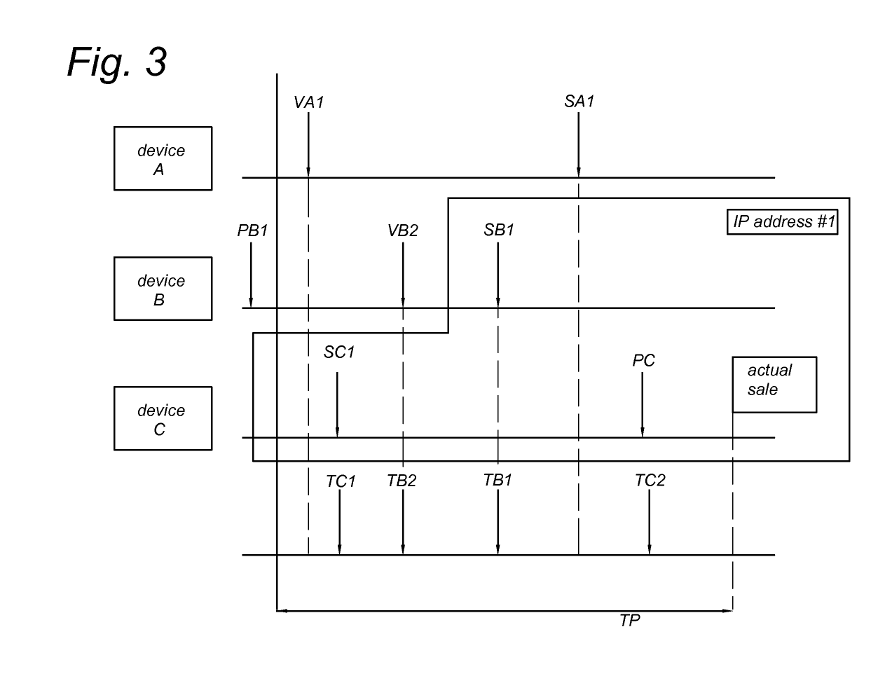

In a further embodiment, which is shown in the timing diagram of FIG. 3, the visit data comprises stored data (e.g. a cookie or cookie file(s), saved on the at least one device during a visit to the web shop website or an associated product website, the stored data comprising at least the product identification. The product identification may be available directly or indirectly, i.e. via an association with the product identification, such as the URL of the page the decision making unit visits. The product identification then again allows to execute a proper matching, gathering visit data and assembling a complete customer journey. Thus also the earlier visit in the tracking period TP to the web shop website using device B (event V_{B2}) is recorded in the customer journey as touch point T_{B2}. The entire customer journey in this embodiment and for this exemplary purchase then already includes four touch points T_{C1}, T_{B2}, T_{B1} and T_{C2} and the associated visit data.

In a further embodiment, the visit data comprises data obtained from at least one device during a visit of the web shop web site relating to user agent data and/or IP hash data. This may depend on the actual implementation of the web shop web site and associated web sites, yet still allows to perform proper matching for assembly of the customer journey.

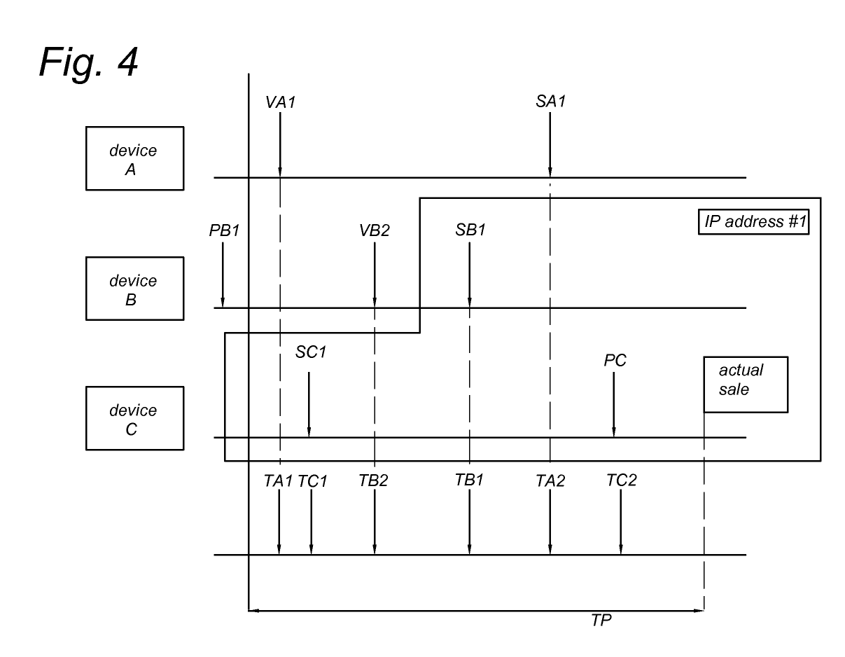

The customer journey can be made even more complete using an even further embodiment of the present invention, for which the timing diagram is shown in FIG. 4. In this embodiment, a decision making unit identification is provided to each of the at least one devices, such as an email address or an account identification, and the decision making unit identification is included in the gathered data. This embodiment also allows to properly add the visits by the decision making unit using device A in the example as shown, i.e. the visit event V_{A1} and event S_{A1}. As shown in FIG. 4, these are added as touch points T_{A1} and T_{A2} in the eventual customer journey, resulting in a complete view of the purchase history by the decision making unit in the tracking period TP (i.e. a total of six touch points). It is noted that the email address data mentioned in this embodiment (and also in the other embodiments described) might be in the form of a hashed email address, in order to secure privacy.

In a further embodiment, the visit data is obtained based on data retrieved from the decision making unit identification. The decision making unit identification is e.g. an email address as used, or an account identification. The email address or the account identification could be obtained during the actual purchasing phase. Matching of all the gathered data (i.e. product identification, IP address, cookie data, decision making unit identification) then allows to assemble the entire customer journey. Then, after the actual sale (purchase), the customer journey and the gathered data are e.g. used to compute contributions of separate touch points on the customer journey towards the actual sale of the product.

Of course, by extending the tracking period TP, even more earlier events may be included (e.g. purchase event P_{B1}) in the customer journey, but in general determination of marketing measurements can be limited to a set time period.

The present invention embodiments can thus be utilized to provide more complete customer journey records and data, even when the decision making unit is using multiple devices or multiple locations towards the actual purchase. Even in the case of off line purchasing (i.e. in a physical shop) the present method embodiments can be used (see below).

In the situation of multiple locations and a single device, the decision making unit e.g. uses a single device to orientate on a product using a (mobile) computer device on work, and buy the product when at home, or check a product in a train to work, and order the product at work, or e.g. check a product on the computer device at a friend's house, and order from the same computer device at home. As a single computer device is used, the embodiment relying on cookies is already sufficient to obtain the entire customer journey, since it is the same computer device the cookies should still be there when the eventual purchase is made. If cookies are deleted, then the embodiment using matching from cookie identifications derived from the decision making unit (e-mail/account id) can be used.

In the situation of a single location and multiple devices, the situation can e.g. be that a decision making unit opens an e-mail relating to the product on a smart phone, after which the product is bought using a laptop at home. Also, a natural person can browse together with a partner on a smart phone and laptop at the same time, after which one person buys the product from one of these devices (or another device in the same location). Also a more complex situation can be catered for, e.g. when a person checks products using a default browser, yet orders a product using another browser.

Also in the combined situation (multiple locations, multiple devices) the present invention embodiments allow to assemble a complete and useable customer journey. E.g. a person checks a product using a work laptop, forwards a link to a partner and let that partner buy the product (they form a single decision making unit for that purchase). Or a promotional advertisement/link is received at work, the person directly checks it out, however, buys the product later at home using a different device. Also the following situation is possible: buy a product from retailer X on device A (cookie set is stored); order the product from retailer Y from device B (also cookie set is stored). It is known that both cookie identifications belong to a single decision making unit (e.g. based on e-mail identification), so it is possible to check if the decision making unit also visited retailer Y from device A (can be on same or different location). This would be possible e.g. if an association between the different cookie sets exists, e.g. originating from an earlier purchase at retailer Y via device A by the same decision making unit. In that case an email or account identification would allow to retrieve associated cookie sets.

Even the following situation allows to build an entire customer journey. Orientate at home/work/etc, but buy in a store (other way around is not possible). If an e-mail address is left with the order in the physical store, this e-mail address can be used to find cookie identifications from the online behavior from that same decision making unit for that store.

When using the IP and product identification embodiment as described with reference to FIG. 2 above, company networks can pose a problem. A large number of devices attached to such a company network has the same IP address, resulting in an increasing probability for different people orientating for the same product. Therefore large proxies are excluded in a further embodiment: data from an IP address having more than a predetermined number of different decision making units are excluded.

A similar limitation may be applied in a further embodiment, wherein data relating to matched product identification and IP address of the at least one device are excluded if a number of matches exceeds a predetermined threshold value. This is e.g. the case for massively popular products. For instance during the release of a new type of smart phone different people from the same location might me orientating for this product (so IP address plus product identification matching not reliable there). It is then not possible to combine these visits into one customer journey, since they are not from the same DMU (Decision Making Unit). Popular products can also be excluded.

The present invention embodiments may be implemented in a system for online marketing measurements relating to purchase of a product on a web shop website by a decision making unit, the system comprising a processing unit connected to the Internet, and arranged to execute the method according to any one of the embodiments described above. Also, the invention may be embodied as a computer program product comprising computer executable code, which when loaded on a computing system, allows the computing system to execute the method according to any one of the embodiments described above.

Aspects of the present invention may be implemented with a centralized or distributed computer system operating environment. In a distributed computing environment, tasks may be performed by remote computer devices that are linked through communications networks. The distributed computing environment may include client and server devices that may communicate cither locally or via one or more computer networks. Embodiments of the present invention may comprise special purpose and/or general purpose computer devices that each may include standard computer hardware such as a central processing unit (CPU) or other processing means for executing computer executable instructions, computer readable media for storing executable instructions, a display or other output means for displaying or outputting information, a keyboard or other input means for inputting information, and so forth. Examples of suitable computer devices include hand-held devices, multiprocessor systems, microprocessor-based or programmable consumer electronics, networked PCs, minicomputers, mainframe computers, and the like.

The method embodiment of the present invention will be described in the general context of computer-executable instructions, such as program modules, that are executed by a processing device, including, but not limited to a personal computer. Generally, program modules include routines, programs, objects, components, data structure definitions and instances, etc, that perform particular tasks or Implement particular abstract data types. Typically the functionality of the program modules may be combined or distributed as desired in various environments,

Embodiments within the scope of the present invention also include computer readable media having executable instructions. Such computer readable media can be any available media that can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions and which can be accessed by a general purpose or special purpose computer. Combinations of the above should also be included within the scope of computer readable media. Executable instructions comprise, for example, instructions and data which cause a general purpose computer, special purpose computer, or special purpose processing device to perform a certain function or group of functions.

The present invention embodiments have been described above with reference to a number of exemplary embodiments as shown in the drawings. Modifications and alternative implementations of some parts or elements are possible, and are included in the scope of protection as defined in the appended claims.

1. A method for online marketing measurements relating to purchase of a product on a web shop website by a decision making unit,
wherein at least one device is used by the decision making unit to visit the web shop website and associated product websites;
the method comprising:
gathering data from the web shop website and associated product websites,
wherein the data comprises a product identification identifying a product for sale in the web shop website, and an IP address of the at least one device;
detecting a match of product identification and IP address of the at least one device;
assembling a customer journey from the decision making unit towards actual purchase of a product from all detected matches of product identification and IP address, the customer journey combining visit data associated with visits by the decision making unit to the web shop website and associated product websites using any of the at least one device and relating to the purchased product.

2. The method of claim 1, wherein the visit data comprises stored data saved on the at least one device during a visit to the web shop website or an associated product website by the decision making unit, the stored data comprising at least the product identification.

3. The method of claim 1, wherein a decision making unit identification is provided to each of the at least one device, such as an email address or an account identification, and wherein the decision making unit identification is included in the gathered data.

4. The method of claim 3, wherein the visit data are obtained based on data retrieved from the decision making unit identification.

5. The method of claim 1, wherein the visit data comprises data obtained from at least one device during a visit of the web shop web site relating to user agent data and/or IP hash data.

6. The method of claim 1, wherein data from an IP address having more than a predetermined number of different decision making units are excluded.

7. The method of claim 1, wherein data relating to matched product identification and IP address of the at least one device, are excluded if a number of matches exceeds a predetermined threshold value.

8. The method of claim 1, wherein the customer journey and the gathered data is used to compute contributions of separate points on the customer journey towards the actual sale of the product.

9. A system for online marketing measurements relating to purchase of a product on a web shop website by a decision making unit,
the system comprising a processing unit connected to the Internet,
wherein at least one device is used by the decision making unit to visit the web shop website and associated product websites;
the system being arranged for:
gathering data from the web shop website and associated product websites,
wherein the data comprises a product identification identifying a product for sale in the web shop website, and an IP address of the at least one device;
detecting a match of product identification and IP address of the at least one device;
assembling a customer journey from the decision making unit towards actual purchase of a product from all detected matches of product identification and IP address, the customer journey combining visit data associated with visits by the decision making unit to the web shop website and associated product websites using any of the at least one device and relating to the purchased product.

10. The system of claim 9, wherein the visit data comprises stored data saved on the at least one device during a visit to the web shop website or an associated product website by the decision making unit, the stored data comprising at least the product identification.

11. The system of claim 9, wherein the system is further arranged to provide a decision making unit identification to each of the at least one device, such as an email address or an account identification, and wherein the decision making unit identification is included in the gathered data.

12. The system of claim 9, wherein the system is further arranged to exclude data from an IP address having more than a predetermined number of different decision making units.

13. The system of claim 9, wherein the system is further arranged to exclude data relating to matched product identification and IP address of the at least one device if a number of matches exceeds a predetermined threshold value.

14. The system of claim 9, wherein the system is further arranged to use customer journey and the gathered data to compute contributions of separate points on the customer journey towards the actual sale of the product

15. A computer program product comprising computer executable code, which when loaded on a computing system, allows the computing system to execute a method for online marketing measurements relating to purchase of a product on a web shop website by a decision making unit, wherein at least one device is used by the decision making unit to visit the web shop website and associated product websites;
the method comprising:
gathering data from the web shop website and associated product websites,
wherein the data comprises a product identification identifying a product for sale in the web shop website, and an IP address of the at least one device;
detecting a match of product identification and IP address of the at least one device;
assembling a customer journey from the decision making unit towards actual purchase of a product from all detected matches of product identification and IP address, the customer journey combining visit data associated with visits by the decision making unit to the web shop website and associated product websites using any of the at least one device and relating to the purchased product.

16. The computer program product of claim 15, wherein the visit data comprises stored data saved on the at least one device during a visit to the web shop website or an associated product website by the decision making unit, the stored data comprising at least the product identification.

17. The computer program product of claim 15, wherein the visit data comprises data obtained from at least one device during a visit of the web shop web site relating to user agent data and/or IP hash data.

18. The computer program product of claim 15, wherein data from an IP address having more than a predetermined number of different decision making units are excluded.

19. The computer program product of claim 15, wherein data relating to matched product identification and IP address of the at least one device, are excluded if a number of matches exceeds a predetermined threshold value.

20. The computer program product of claim 15, wherein the customer journey and the gathered data is used to compute contributions of separate points on the customer journey towards the actual sale of the product.
